(19) United States
(12) Patent Application Publication
(10) Pub. No.: US 2012/0117511 A1
(43) Pub. Date: May 10, 2012

(54) METHOD AND APPARATUS FOR PROVIDING AN EXTERNAL MENU DISPLAY

(75) Inventors: Tanmay Agnihotri, San Diego, CA (US); DongWook Kim, San Diego, CA (US); Sathyabama Singaravelu, San Diego, CA (US)

(73) Assignee: Sony Corporation, Tokyo (JP)

(21) Appl. No.: 13/100,208

(22) Filed: May 3, 2011

Related U.S. Application Data
(60) Provisional application No. 61/411,619, filed on Nov. 9, 2010.

(51) Int. Cl. G06F 3/048

(52) U.S. Cl. 715/810

(57) ABSTRACT

Systems and methods are provided for sending a data request from a secondary display device to a main display device for menu data present on the main display device, wherein the main display device is capable of performing a set of functions and wherein the menu data corresponds to the set of functions, receiving the menu data associated with the data request, generating a menu at the secondary display device according to the data and displaying the menu such that the menu provides the user with means for viewing one or more of the set of functions, receiving a selection with relation to the menu to perform at least one function of the one or more of the set of functions from a user at the secondary display device and sending a command to the main display device to perform the at least one function at the main display device.

This application claims the benefit of U.S. Provisional Application No. 61/411,619, filed Nov. 9, 2010, entitled “TV Guide Widget on DASH”, which is incorporated in its entirety herein by reference.

### BACKGROUND OF THE INVENTION

Often, when viewing media such as movies or television programming, viewers may want to view guide data or menu information to select a different channel, set programming reminders, and/or cause some menu functionality. While watching media content on a display, e.g. TV, when a menu is requested or guide data is displayed, the main content size is reduced or some portion thereof is covered which hampers the TV viewing experience of the user.

### SUMMARY OF THE INVENTION

Several embodiments of the invention provide a method comprising sending an data request from a secondary display device to a main display device for menu data present on the main display device, wherein the main display device is capable of performing a set of functions and wherein the menu data corresponds to the set of functions, receiving the menu data associated with the data request, generating a menu at the secondary display device according to the data and displaying the menu such that the menu provides the user with means for viewing one or more of the set of functions, receiving a selection with relation to the menu to perform at least one function of the one or more of the set of functions from a user at the secondary display device and sending a command to the main display device to perform the at least one function corresponding to the selection to cause the at least one function to be performed at the main display device.

In one embodiment, the invention can be characterized as a device comprising a processor configured to perform steps comprising sending an data request from a secondary display device to a main display device for menu data present on the main display device, wherein the main display device is capable of performing a set of functions and wherein the menu data corresponds to the set of functions, receiving the menu data associated with the data request, generating a menu at the secondary display device according to the data and displaying the menu such that the menu provides the user with means for viewing one or more of the set of functions, receiving a selection with relation to the menu to perform at least one function of the one or more of the set of functions from a user at the secondary display device and sending a command to the main display device to perform the at least one function corresponding to the selection to cause the at least one function to be performed at the main display device.

In another embodiment, the invention can be characterized as a tangible non-transitory computer readable medium storing one or more computer readable programs adapted to cause a processor based system to execute steps comprising sending an data request from a secondary display device to a main display device for menu data present on the main display device, wherein the main display device is capable of performing a set of functions and wherein the menu data corresponds to the set of functions, receiving the menu data associated with the data request, generating a menu at the secondary display device according to the data and displaying the menu such that the menu provides the user with means for viewing one or more of the set of functions, receiving a selection with relation to the menu to perform at least one function of the one or more of the set of functions from a user at the secondary display device and sending a command to the main display device to perform the at least one function corresponding to the selection to cause the at least one function to be performed at the main display device.

In a further embodiment, the invention may be characterized as a method comprising sending an data request from a secondary display device to a main display device over a communication channel for data present on the main display device, wherein the data comprises data corresponding to a program guide present at the main display device, the program guide comprising one or more selectable descriptors corresponding to one or more multimedia content and receiving the data corresponding to the data request, generating a program guide displaying the one or more selectable descriptors at the secondary display device, receiving a selection of a first one of the one or more selectable descriptors corresponding to a first one of the one or more multimedia content and sending a command to the main display device in response to the selection for causing the main display device to playback the first one of the one or more multimedia content for the user.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is an exemplary environment in which one or more methods or techniques described with respect to the present invention may be implemented, according to several embodiments of the present invention.

FIG. 2 is a block diagram of elements of an exemplary main display device and secondary display device, and the overall communication between the devices, according to several embodiments of the present invention.

FIG. 3 is a block diagram of the exemplary types of communication between the main display device, and the secondary display device, according to several embodiments of the present invention.

FIG. 4 is a flow diagram of a method performed at the secondary display device for establishing communication and interacting with the main display device, according to several embodiments of the present invention.

FIG. 5 is a flow diagram of a process for generating a content guide and receiving content selections, according to several embodiments of the present invention.

FIG. 6 is a flow diagram of a process for generating a menu corresponding to a first main display device for the user at the secondary display device, according to several embodiments of the present invention.

FIG. 7 is a flow diagram of a process performed at the main display device for communication with the secondary display device and providing data and performing commands in response to requests from the secondary display device, according to several embodiments of the present invention.

FIG. 8 is an exemplary process flow of commands between the secondary display device and the main display device, according to several embodiments of the present invention.

FIG. 9 is an exemplary set of requests and responses sent between the secondary display device and the one or more main display devices to perform device discovery, according to several embodiments of the present invention.

FIG. 10 is a block diagram illustrating a processor-based system that may be used to run, implement and/or execute the methods and/or techniques shown and described herein in accordance with embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

While watching media content on a display, e.g. TV, when a menu is requested or guide data is displayed, the main content size is reduced or some portion thereof is covered which hampers the TV and media viewing experience of the user. In one embodiment, the present invention provides a secondary display device, e.g. the DASH device, used to provide the user with an optimal viewing experience. Displaying Menus and content guide listings on the secondary display device is will enhance the media viewing experience. The viewer is able to see the content guide listings and menu information and options on the secondary display device anywhere in the house without disturbing the media viewers. The TV guide data obtained on the main display device, e.g. TV can be transmitted and displayed on the secondary display device. The user can then browse all the guide data on the secondary display device, select the channel to watch, and transmit this information back to the main display device, e.g. TV. Similarly, with respect to menus, menus corresponding to the main display device, or other consumer electronic device, can be generated and displayed at the secondary display device and selections can be received from the user and transmitted back to the main display device, e.g. TV. During this period the size of main content being viewed does not have to be reduce and portions of content do not have to be covered or obscured. Thus, the present invention would enhance the content viewing experience while still providing the user of the devices with the same functionalities and capabilities as provided with existing media viewing.

Furthermore, the present invention additionally provides for an alarm feature at the secondary display device, e.g. DASH. In one or more embodiments, the user can select favorite programs from the guide displayed at the secondary display device and set the playtime as an alarm. In some embodiments, at the specified program time, the secondary display device may power on the main display device, e.g. TV, in the event the device is turned off, and tune to the particular program/channel. In an additional or alternative embodiment, the secondary display device may play an alarm tone to notify the user about switching and tuning to the specified channel. This feature thus enhances the viewer experience and showcases the compatibility between two devices, i.e. the main display device displaying the actual content, and the secondary display device, displaying content guide and menus.

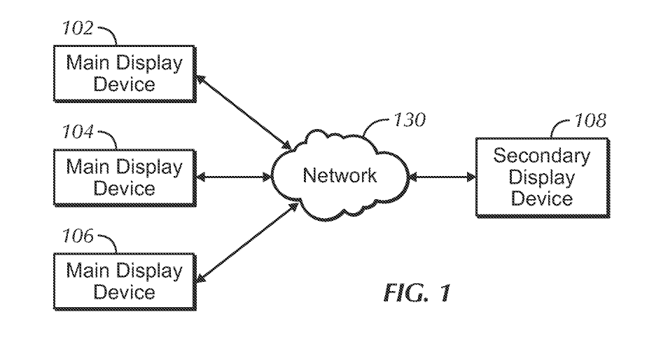

FIG. 1 illustrates an exemplary environment in which one or more methods or techniques described with respect to the present invention may be implemented. As illustrated, in one embodiment, the exemplary embodiment comprises one or more main display devices 102, 104, 106 communicatively coupled to secondary display device 108, through a network 130. In one embodiment, the network 130 comprises a home network, a local area network (LAN), a wide area network (WAN), or any other type of network allowing for communication between the main display devices 102, 104 and 106 and secondary display device 108.

In one embodiment, the one or more main display devices 102, 104 and 106 comprise consumer electronic devices such as a TV, computer, tablet, mobile device, game console, DVD/Blue ray player, etc. In one embodiment, one or more of the main display devices 102, 104 and 106 comprise display functionality for displaying content to a user. In another embodiment, one or more of the main display devices 102, 104 and 106 comprise a set of functionalities selectable by a user at the device through a menu displayable to the user. In another embodiment, one or more main display devices are configured to access guide data corresponding to media available for consumption, e.g. viewing, at the main display device which is selectable by the user. While only three main display devices have been displayed herein, it should be understood that any number of main display devices may be coupled to one another and/or the secondary display device through network 130.

In one embodiment, the secondary display device 108 comprises a device having display capability, for receiving menu data and/or guide data from one or more of the main display devices 102, 104 and 106 and for displaying a menu and/or content guide to the viewer for causing a function to be performed at the main display device or for viewing content available for consumption at the main display device. In one embodiment, the menu data comprises a list of functionalities performable by a particular one of the main display devices 102, 104 and 106. In one embodiment, the menu data is stored locally at the main display device 102, 104 and 106. In some embodiments, the guide data comprises a list of content available for consumption at the main display devices 102, 104 and 106 and may further comprise additional information corresponding to the content available for consumption. In one embodiment, the guide data is locally available at the main display device.

In one or more embodiments, the one or more main display devices 102, 104 and 106 and the secondary display device 108 may reside within a home network, LAN, WAN or other network where the main display devices and the secondary display device are discoverable by one another. In one embodiment, the user of the secondary display device may be able to access and control multiple devices within the network using the secondary display device. In one embodiment, to enable control of multiple devices within the network, the secondary display device is configured to discover one or more devices within the network available for control.

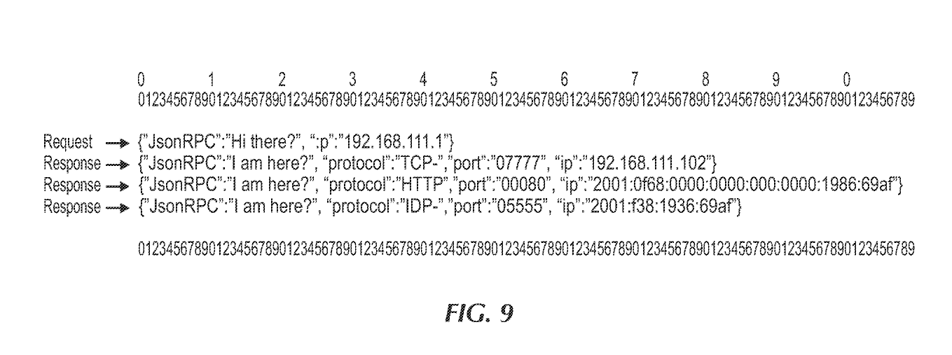

According to several embodiments, the device discovery feature helps the user find what devices are available out there to control. In one or more embodiments, the discovery of devices may be performed at the secondary display device upon device initialization, upon powering on the secondary display device each time, periodically according to a system or user assigned schedule, and/or upon a user request to refresh the list of available devices. In one embodiment, the process of device discovery comprises the secondary display device sending out a request first to find one or more main display devices in the same network. Each of the one or more main display devices may then reply to tell its existence. FIG. 9 illustrates an exemplary set of request and responses sent between the secondary display device and the one or more main display devices to perform the device discovery, according to one embodiment.

As illustrated in FIG. 9, in the exemplary embodiment, the request sent from the secondary display device includes two elements: a message element and an IP address of the secondary display device. In one embodiment, the message element comprises a JSON RPC message. In one embodiment, each response corresponds to a device within the network and comprises four elements: a message element, a protocol, port and IP of the device. In one embodiment, the message element comprises a JSON RPC message. In one embodiment, the JSON RPC message of the response is a message recognizable as a discovery message. For example, in this embodiment, the JSON RPC message is “I am here”.

In one exemplary embodiment, the request and response commands may be sent out as a UDP broadcast packet through port “9786”. In such embodiments, the device discovery feature is only available for devices within a local area network. According to this embodiment, both commands are delivered in 128 fixed size of message with null padding characters at the end. The size of 128 is long enough to contain the ipv6 version of IP address. In another embodiment, other communication formats may be adopted to allow for device discovery within other types of networks and/or to achieve more optimal results depending on the specific types of devices, and/or environment.

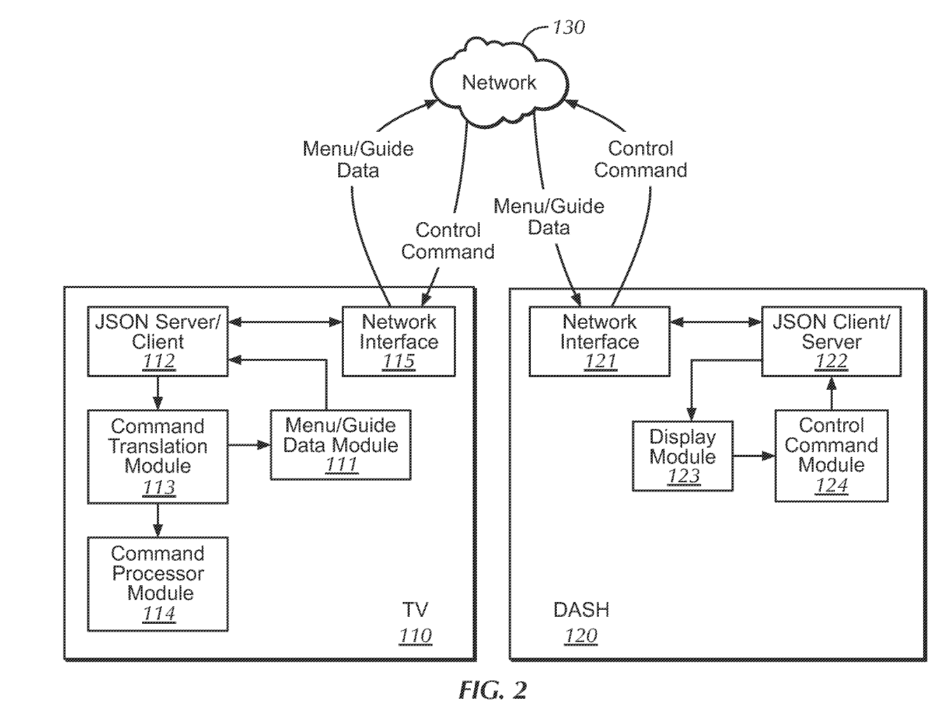

Referring to FIG. 2, a block diagram of elements of an exemplary main display device and secondary display device, and the overall communication between the devices is illustrated according to several embodiments of the present invention.

While in this exemplary embodiment the main display device is illustrated s a television, it should be understood by one or ordinary skill in the art that any of the above mentioned or other consumer electronic devices could be implemented as the main display device having one or more of the modules described below and configured to perform the methods and techniques described throughout with respect to the present invention. Further, while for exemplary purposes the secondary display device is displayed as the DASH device, it should be understood by one of ordinary skill in the art that any device having display capabilities and capable of establishing a communication with a main display device over a network comprising one or more of the modules described below may be configured to perform the techniques and methods described throughout with respect to the secondary display device of the present invention.

As illustrated, the TV 110 is in communication with the DASH device 120 over a network 130. In one embodiment the network may comprise a wired or wireless connection between the TV 110 and DASH device 120. In one embodiment the communications over the network are achieved through JavaScript Object Notation (JSON) commands. In other embodiments, alternative communication protocols may be used to enable communication between the TV 110 and DASH 120.

As illustrated, TV 110 comprises a menu/guide data module 111, a JSON server/client 112, a command translation module 113, a command processor module 114 and a network interface 115. In one embodiment, the menu/guide data module 111 is configured to retrieve guide data and/or menu data to be sent to the DASH 120 for display to the user. In one embodiment, the guide/menu data is stored at the TV 110 and the menu/guide data module 111 is configured to retrieve the data from the storage at the TV 110. In another embodiment, the menu/guide data module 111 is further configured to download the data to the TV from an external storage device, database or server. In one embodiment, the menu/guide data module is configured to receive a request or command to send guide data or menu data to the DASH device, e.g. a GetTvGuide command. In one embodiment, the guide/menu data module 111 is further configured to generate a guide or menu data XML file by reading the data from a local or remote storage or downloading the data.

The JSON server/client 112 is configured to receive the data from the menu/guide data module 111 and configured to transmit the data to the DASH 120. Furthermore, the JSON server/client 112 is further configured to receive commands form the DASH client for retrieving data and/or performing one or more functionalities at the TV 110. In one embodiment, the command and data transmissions are performed using JSON RPC.

The JSON server/client 112 is configured to send the guide and/or menu data to the DASH device through the network interface 115. In one embodiment, network interface 115 is configured to establish a connection to the DASH device through network 130 and configured to send data and receive commands to and from the DASH device 120.

The command translation module 113 at the TV 110 is configured to receive commands sent from the DASH device, and configured to translate the control commands to commands executable at the TV 110. For example, in one embodiment, the commands sent from the DASH device comprise JSON commands. In one embodiment, the TV 110 is configured to execute remote control commands, e.g. commands executed in the SIRCS protocol. In one embodiment, to enable the TV 110 to execute the commands received from the DASH, while allowing the TV processing functionalities to remain the same, i.e. such that the TV is still capable of executing the same protocol of commands as any typical or existing TV, the command translation module is configured to translate the command into a command executable by the main display device.

In one embodiment, the commands received at the command translation module may comprise a get data command, e.g. a request for TV guide or menu data. In such embodiments, the command may be forwarded to the menu/guide data module such that the data corresponding to the get data command can be retrieved and forwarded to the DASH device. In one embodiment, before forwarding the command to the menu/guide data module 111, the command is translated to a command executable by the menu/guide data module 111. In another embodiment, where the commands comprise control commands, i.e. commands to perform some functionality at the TV 110, the command translation module is configured to translate and forward the commands to the command processor module 114 for processing.

The command processor module 114 is configured to receive the translated commands, implemented in a protocol executable at the TV and configured to execute those commands. For example, where the commands comprise a menu selection or a command to cause some functionality at the television, e.g., volume change, turning the TV on or off, waking the TV up, changing the channel, etc., the command received from the DASH is translated into a corresponding remote control or other TV executable command that is executable by the command processor module 114 to cause the function of the control command to be performed at the TV 110. In one embodiment, the command processor module may further be in communication with other elements of the TV (not shown herein) for displaying or performing one or more of the functionalities associated with a control command received from the DASH device 120.

The DASH device 120 comprises a network interface 121, a JSON client/server 122, a display module 123 and a control command module 124. The network interface 121 is configured to establish a connection and communication with the network interface 115 at the TV and to send commands and received menu and/or guide data over the network 130. In one embodiment, the menu and/or guide data and commands are transmitted and received using JSON commands. The network interface 121 is further coupled to the JSON client server 122, and configured to receive the commands from the JSON client/server 122 and forward the received data to the JSON client/server 122.

The JSON client/server 122 is coupled to the network interface 121 and further coupled to the display module 123 and control command module 124. The JSON client/server is configured to receive menu/guide data from the TV and forward the menu/guide data to be displayed to the viewer by the display module 123. In one embodiment, the processing of the data and generation of the guide and/or menus is performed at the display module 123 and/or the JSON client/server 122.

The display module 123 in several embodiments is configured to receive data received at the DASH device and to generate a TV guide display and/or menu display to be displayed to the user. In one embodiment, the data received at the JSON client/server comprises XML data and the display module 123 is configured to read the XML data to generate the guide or menu display. In one embodiment, the JSON client/server may process the data before being sent to the display module 123. In one embodiment, the display module comprises a FLASH application and/or FLASH capability for generating menu and content guide displays presented to the user at the secondary display device, i.e. DASH.

The control command module 124 is configured to detect a selection made by a user of the DASH 120 and configured to issue a control command to be sent to the TV for retrieving data, selecting a program, and/or performing functionality at the TV 110. In one embodiment, the selection by the user is received upon the display module 123 displaying one or more of a guide and menu information to the user. In one embodiment, the user may enter a selection through various user input means such as buttons, joystick, mouse, touch pad, touch screen, etc. Upon the selection being detected, according to several embodiments the control command module 124 is configured to generate a command and forward the command to the JSON client/server for transmitting to the TV over network 130. In one embodiment, the command generated at the control command module comprises a JSON command. In another embodiment, the control command module may generate commands implemented in a different protocol and a translation module either separate or integrated into the control command module 124 or JSON client/server may translate the command to a JSON command to be sent over the network 130.

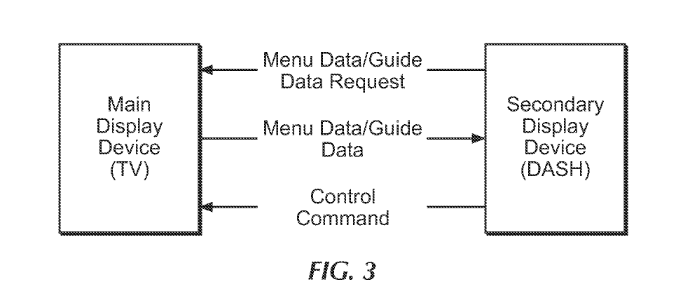

Referring next to FIG. 3, a block diagram of the exemplary types of communication between the main display device, e.g. TV, and the secondary display device, e.g. DASH is illustrated. As illustrated the main display device, e.g. TV, is configured to sent Menu data and/or guide data to the secondary display device. In turn the secondary display device, e.g. DASH, is configured to forward menu data and/or guide data requests as well as control commands to the main display device.

In one or more embodiments, the transmission of content guide data and/or menu data onto the secondary display device is achieved using JSON Remote Procedure Call (JSON RPC). As described above, in one or more embodiments the main display device, e.g. TV, comprises a JSON client/server running. Similarly, according to several embodiments, the secondary display device, e.g. DASH, further comprises a JSON client/server. In one embodiment, once the guide data is downloaded onto the main display device, the data can be transmitted to the secondary display device using JSON RPC. In one embodiment, the guide data is displayed and the user can scan the data and choose the content he wants to view. Once the content is selected, the secondary display device, according to one embodiment, sends the channel number to be played on the main display device as a JSON command. The main display device interprets the JSON commands and converts this command into a protocol executable at the main display device, e.g. a remote control protocol such as SIRCS, to tune to the specific channel/programming.

Similarly with respect to menu information, according to several embodiments, menu information at the main display device is transmitted to the secondary display device using JSON RPC, according to one embodiment. In such embodiments, the menu data is received at the secondary display device and a menu is generated for display to the user. In one embodiment, the menu comprises one or more functionalities offered by the main display device. Next, according to several embodiments, the menu is displayed to the user and the user is able to select a functionality to be performed at the main display device. In one embodiment, the functionality may comprise volume up/down, power on/off, brightness settings, channel selections, view guide and/or other menu functionalities performable at the main display device. The secondary display device then may issue a JSON command and send the JSON command to the main display device. The main display device, is one embodiment, receives the JSON commands and converts this command into a protocol executable at the main display device, e.g. a remote control protocol such as SIRCS, to perform the desired functionality.

The menu data and/or guide data requests sent from the secondary display device may comprise JSON commands in one or more embodiments. In one embodiment, the data request is issued at the secondary display device in response to a user selection, e.g. a selection of a particular device, a selection to view guide data, a selection to see a menu associated with a device, a selection to find a particular function to be performed at the device, etc. In one or more embodiments, the secondary display device determines that the data to fulfill the user selection is not available and/or is outdated and generates a get data command, e.g. a JSON command and transmits the command to the main display device.

In several embodiments, the control command may further comprise a JSON command. In one embodiment, the control command corresponds to one or more executable functions at the main display device to cause a certain functionality to be performed. In one embodiment, the control command is issued in response to a user menu selection, channel selection, content selection, etc. In one embodiment, in response to such selection the secondary display device issues a control command to the main display device. The main display device, upon receiving the control command interprets the command and performs a particular functionality in view of the command, e.g. tuning into a particular channel, changing the volume, changing the brightness, turning the device on, and/or other guide or menu selection functionalities available at the main display device.

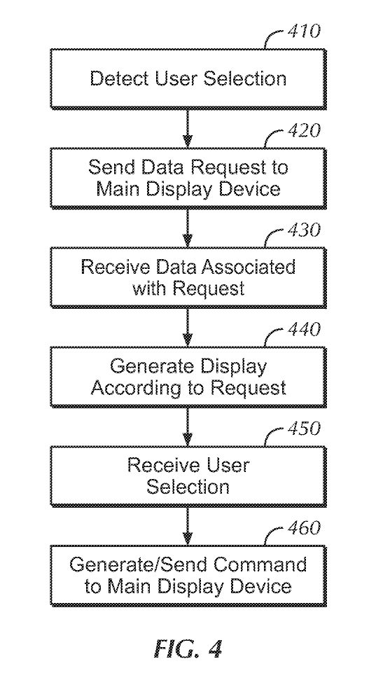

Referring to FIG. 4, a flow diagram of a method performed at the secondary display device for establishing communication and interacting with the main display device is illustrated according to several embodiments of the present invention.

The process begins in step 410 when the secondary display device detects a user selection, and detects that to fulfill the user selection some data stored at the main display device is necessary. In one embodiment, for example, the user selection may comprise a selection of a device, a request to view a menu associated with a device, a request to see a content guide/menu associated with the device, a request to update or customize a menu associated with a device, and/or a request to update a guide associated with the device.

According to one embodiment, once the secondary display device receives the user selection, the secondary display device may determine whether the information necessary for fulfilling the user selection is available at the secondary display device, or whether some or all of the data should be retrieved from the main display device. If the data is available locally, then the process moves to step 440 and generates the guide. Otherwise, when it is determined that at least some of the data is not locally available at the secondary display device, then the secondary display device generates a get data command for the necessary information not locally available. In step 420 the secondary display device sends the get data request to the main display device. In one embodiment, the get data request comprises a JSON command.

Next, in step 430, the secondary display device receives the data associated with the request. In one embodiment, the data is received at the secondary display device in XML format according to JSON RPC. The secondary display device receives the data and is configured to parse the data. In some embodiments, the data may be either temporarily or permanently stored at a storage at the secondary display device. In one embodiment, the data may be buffered as it is being received at the secondary display device.

The process then continues to step 440 and a display according to the request is generated. In one embodiment, the display comprises a display corresponding to the user selection detected in step 410. For example, in one embodiment, the display may comprise a menu corresponding to the main display device, a content guide of content available for consumption at the main display device and/or other data available at the main display device. The display is then provided to the user and the user is able to scan the display and may make one or more selections from the display.

The secondary display device then begins monitoring for user selections with respect to the display. In step 450, the secondary display device detects a user selection. In one embodiment, the selection may for example comprise a content selection, a request to perform a particular functionality at the main display device according to a menu and/or a request to set an alarm for a particular content.

Upon detecting the user selection, the process moves to step 460 and a control command corresponding to the user selection is generated. In one embodiment, the control command comprises a JSON command. In one embodiment, the command corresponds to one or more functions performable at the main display device to cause a function or action to be carried out. In one embodiment, for example, the command may correspond to a change channel command, a volume up/down command, a power on/off command, a view guide command, etc. Once the command is generated, the control command is then transmitted to the main display device. In one embodiment, upon performing the command the main display device may provide an acknowledgment message to the secondary display device. In one embodiment, the acknowledgment may comprise a success or failure message, time the action was executable, an acknowledgment that the message was received, etc.

In some embodiments, when the selection compromises a request to set an alarm, the alarm data may then be stored at the device until the time where the specific program time/alarm time has been reached. In some embodiments, at the specified program time, the secondary display device may issue a control command, according to the methods and techniques described herein, to power on the main display device, e.g. TV, in the event the main display device is turned off, and may further issue a command to the main display device to cause the TV to tune to the particular program/channel. In one embodiment, the control commands for powering on the main display device and for tuning to the particular channel/program may be implemented as two separate commands, while in another embodiment, a single command may be interpreted at the main display device to cause two separate executable commands, one to turn on the main display device, and a second executable command to tune to the specific channel or program.

In one embodiment, the turn on command may only be available in main display devices capable of monitoring for and receiving messages when powered off In one embodiment, for example the main display device may not be completely turned off and instead in a sleep or hibernation mode such that it can receive messages. In an additional or alternative embodiment, the secondary display device may further be configured to play an alarm tone to notify the user about switching and tuning to the specified channel.

As described above the process described above can be used to provide the user with a content guide and or menu display that will not effect the viewing experience of the user, i.e. a display of the guide data or menu data does not require a reduction in size of main content being displayed, and/or blocking of some portion of the data with the displayed guide or menu. Furthermore, in some embodiments, the present methods and techniques may be employed to provide for an alarm feature at the secondary display device. In one or more embodiments, the user can select favorite programs from the guide displayed at the secondary display device and set the playtime as an alarm.

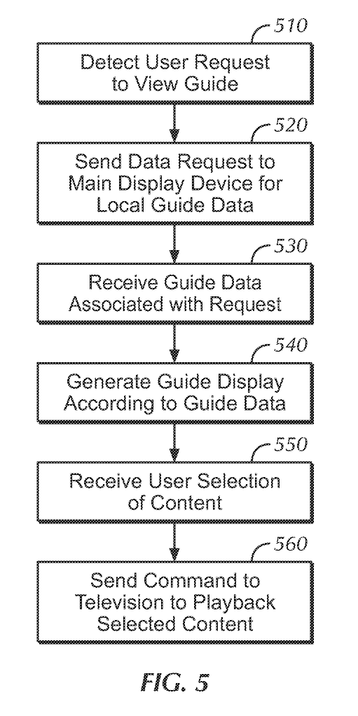

Referring next to FIG. 5 a more detailed flow diagram of a process for generating a content guide and receiving content selections is illustrated according to one or more embodiments of the present invention.

First, in step 510, the user detects a user request to view a content guide corresponding to a first main display device. In one embodiment, the selection comprises a menu selection or other input entered by the user at the secondary display device. In one embodiment, the selection may be received through one or more user input devices, comprising for example, a mouse, keyboard, buttons, touch pad, touchscreen, etc.

In step 520, the secondary display device generates and sends a data request command to the main display device for local guide data. In one embodiment, the local guide data comprises a list of content available for consumption at the main display device. In one embodiment, the local guide data may further comprise information regarding the content available for consumption. In one embodiment, the guide data is stored locally at the main display device.

Next, in step 530, the secondary display device receives the guide data associated with the request. In one embodiment, the guide data is received at the secondary display device as XML data.

In step 540, the secondary display device parses the received data, e.g. the XML packet of data and generates a content guide display according to the received data. In one embodiment, the content guide display comprises a list of content available for consumption at the first main display device. In one embodiment, the content guide display may further comprise additional information corresponding to one or more of the available content. Such information may comprise for example, the content identifier, the content start and end time, type of content, etc. Upon generating the content guide in one embodiment the secondary display device then displays the guide to the user. The user is able to scan the content guide display and select one or more content for consumption. In one embodiment, upon displaying the content guide display, the secondary display device begins monitoring for user selection of content from the content guide.

In one embodiment, in step 550 a user selection of one or more content within the display is detected. In one embodiment, the user selection may comprise a selection of content for consumption. In another embodiment, the selection may comprise a request for additional data regarding the content. In one embodiment, if additional information is necessary, the additional information is displayed to the user at the secondary display device. In another embodiment, the additional information may not be available at the secondary display device and the secondary display device may issue a get data command to the main display device to retrieve the additional information.

When the user selection comprises a content selection, then the process continues to step 560 and issues a command to the main display device to play back the content at the main display device. In one embodiment, the command comprises a JSON control command.

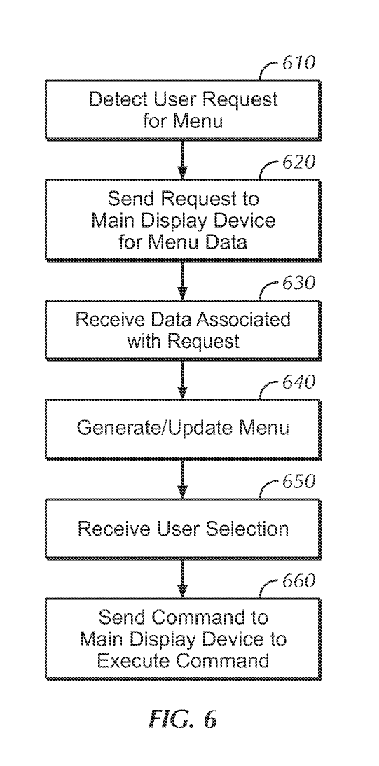

Referring to FIG. 6 a flow diagram of a process for generating a menu corresponding to a first main display device for the user at the secondary display device is illustrated according to one or more embodiments of the present invention.

The process begins in step 610 when the secondary display device detects a user request for viewing a menu corresponding to a first device. In one embodiment, for example a user may make a selection corresponding to a selection of a device, a request to view a menu associated with a device, a request to update or customize a menu associated with a device, etc.

In one embodiment, upon detecting the user request, the secondary display device may determine whether the information necessary for generating and displaying a menu corresponding to the device is available locally. If such data is available locally, then the secondary display device may simply move to step 640 and generate the menu for the user.

On the other hand, in one or more embodiments, when it is determined that at least some of the data is not locally available at the secondary display device, then the secondary display device generates a get menu data command for the necessary information not locally available. In step 620 the secondary display device sends the menu data request to the main display device. In one embodiment, the menu data request comprises a JSON command.

Next, in step 630, the secondary display device receives the menu data associated with the request. In one embodiment, the data is received at the secondary display device in XML format according to JSON RPC. The secondary display device receives the menu data and is configured to parse the data. In some embodiments, the data may be either temporarily or permanently stored at a storage at the secondary display device. In one embodiment, the data may be buffered as it is being received at the secondary display device.

The process then continues to step 640 and a menu display according to the received menu data is generated. In one embodiment, the display comprises a menu corresponding to the main display device, comprising a list of functionalities that can be performed at the main display device. The menu display is then provided to the user and the user is able to scan the display and may make one or more selections from the menu display.

In step 650, according to one embodiment, the secondary display device receives a user selection from the display. In one embodiment, the selection may for example comprise a channel selection and/or a request to perform a particular functionality at the main display device according to the menu display such as for example, volume change, brightness change, power on, power off, sleep, etc.

Upon detecting the user selection, the process moves to step 660 and a control command corresponding to the user selection is generated. In one embodiment, the control command comprises a JSON command. In one embodiment, the command corresponds to one or more functions performable at the main display device to cause a function or action to be carried out. In one embodiment, for example, the command may correspond to a change channel command, a volume up/down command, a power on/off command, etc. Once the command is generated, the control command is then transmitted to the main display device.

In another embodiment, the menu selection may comprise a view guide or other selection for viewing additional information. In such embodiments, the secondary display device determines that at least some of the requested data is not locally available. A get data command is issued and sent to the main display device to retrieve the requested data. The data is then received once the user selection is fulfilled at the secondary display device.

In one embodiment, instead of receiving a request from the user to access a device menu, the secondary display device upon discovering each device in the network may initiate a menu generation process to create a default or customized menu for each of the devices within the network. In such embodiments, the device may issue the request and the request is treated similar to receiving a request from the user. In one embodiment, upon initializing each device, the secondary display device may generate and store a default menu corresponding to the device with a list of basic functionalities performable by the device.

In some embodiments, when a user requests to view the menu of the device, this default menu may be presented to the user and the user may make selections based on the menu functionalities shown on the default menu. In additional embodiments, the secondary display device may further provide the user with the option to update and/or customize the displayed menu corresponding to the device. In such embodiments, the request to update is treated similar to a user request detected in step 610 and the information necessary to provide the updated or customized menu is requested to provide the user with an updated or customized menu.

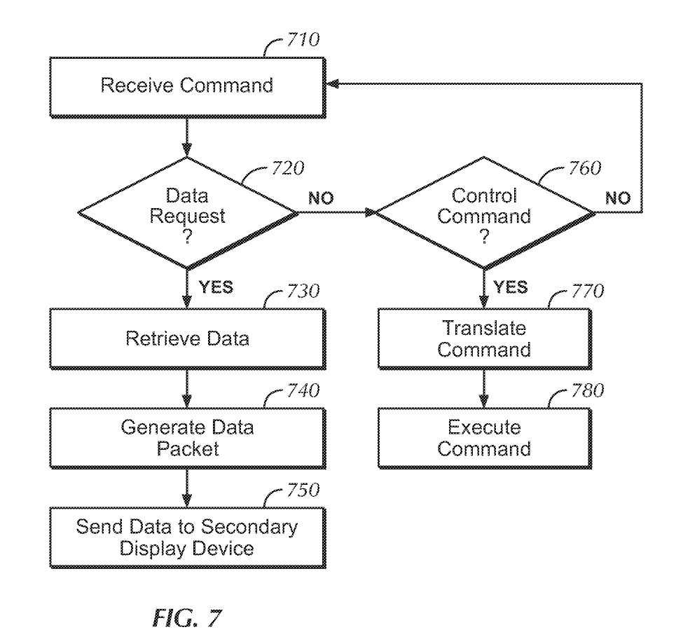

Next referring to FIG. 7 a flow diagram of a process performed at the main display device for communication with the secondary display device and providing data and executing commands in response to requests from the secondary display device is illustrated.

First in step 710, the main display device receives a command over the network. In one embodiment, the command received at the main display device comprises a JSON command. In one embodiment, the command comprises one of a data request command and a control command. In one embodiment, as described above, the command is received at the JSON client/server for processing. In one embodiment, first in step 720 of the process the system determines whether the command comprises a data request command. That is, in one embodiment, the main display device JSON client/server receives a JSON command and parses the command to determine the type of command. In another embodiment, the processing and/or interpretation of the command may be performed within a separate module of the main display device. In one embodiment, each type of command is formatted such that it is differentiable from other types of commands received from the secondary display device. In one embodiment, for example, a header or body of the specific JSON command may comprise a type identifier of the command.

If in step 720 it is determined that the command comprises a data request, the process continues to step 730 and retrieves the data corresponding to the data request. In one embodiment, retrieving the data comprises accessing a local and/or remote database and retrieving the data corresponding to the request. In one embodiment, the data may be accessed from a remote location and downloaded into the main display device in step 730. In one embodiment, the data comprises guide data, and/or menu data for generating a content guide and/or a menu corresponding to the device. In one embodiment, prior to retrieving the data, in one embodiment, the command is interpreted into an executable protocol at the television. In one embodiment, to provide the data to the secondary display device, the data is removed and stored at the main display device. That is, even where the data is not available locally, in such embodiments, the data is first retrieved and downloaded onto the main display device before being sent to the secondary display device.

Next, the process continues to step 740 and generates a data packet comprising the data retrieved in step 730. In one embodiment, the data is stored in XML. In one embodiment, the data packet is generated in XML format and configured to be transmitted to the secondary display device through JSON RPC. Finally in step 750, the main display device transmits the data packet to the secondary display device.

Referring back to step 720, if in step 720 it is determined that the command is not a data request, the process continues to step 760 and determines whether the command comprises a control command. In one embodiment, if it is determined that the command is not a control command, the process ends and the process returns to step 710 and begins monitoring for additional commands from the secondary display device. In another embodiment, if it is determined that the command is not a control command, there may be additional steps or methods performed at the main display device. For example, in one embodiment, the main display device may send a message to the secondary display device to resend the message if it is determined that some error occurred with respect to the device. In another embodiment, the request may comprise a notification and/or acknowledgment message and the main display device may be configured to display and or store the acknowledgment and/or notification.

If on the other hand, in step 760 it is determined that the command comprises a control command, the control command is interpreted in step 770. In one embodiment, as described above, the main display device may comprise a command translation module 113 configured to receive commands, and configured to translate the control commands to commands executable at the main display device. For example, in one embodiment, the commands sent from the secondary display device comprise JSON commands. In one embodiment, the main display device is configured to execute remote control commands, e.g. commands executed in the SIRCS protocol. In one embodiment, to enable the main display device to execute the commands received from the secondary display device, while allowing the main display device processing functionalities to remain the same, i.e. such that the main display device is still capable of executing the same protocol of commands as any typical or existing main display device, the command translation module is configured to translate the command into a command executable by the main display device.

In step 780 the translated command is executed at the main display device. In one embodiment, the execution results in for example a change in volume, channel, brightness, a turning on and/or turning off the main display device. In one embodiment, upon executing the command the main display device may provide the secondary display device with an acknowledgment. In one embodiment, the acknowledgment message may comprise a JSON message and/or sent according to JSON RPC. In one embodiment, the acknowledgment may comprise a success or failure message, time the action was executable, an acknowledgment that the message was received, etc.

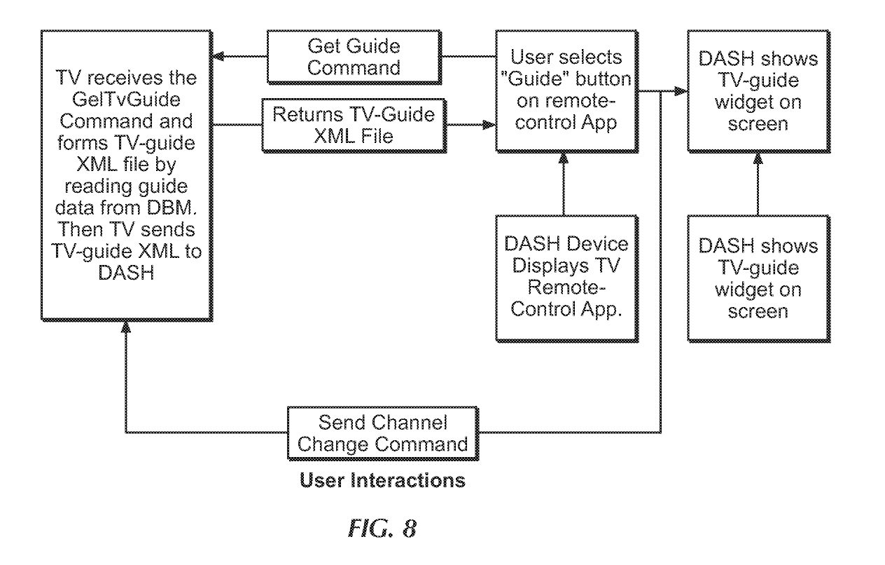

FIG. 8 illustrates an exemplary process flow of commands between the secondary display device and the main display device according to one embodiment of the present invention. It should be noted that the while this exemplary flow only shows the process for displaying a content guide as a result of user interaction, similar flow of commands and data may be useful for achieving other functionality described herein or performable using any of the methods, techniques and apparatuses described herein.

First, according to the exemplary embodiment, the process begins when the DASH device displays the TV remote control application. In one embodiment, the TV remote control application refers to a menu corresponding to the television as described throughout. In one embodiment, the process of retrieving, generating and displaying the TV remote control application is similar to the process described above with respect to FIGS. 4, 6 and 7 for generating a menu display.

Next, the user is able to scan the TV remote control application and selects the Guide button on the remote control application display. The process of retrieving, generating and displaying the TV guide widget is similar to the process described above with respect to FIGS. 4, 5 and 7 for generating a content guide display. As shown, in one embodiment, the process comprises sending a GetGuide Command to the TV. In one embodiment, the command comprises a JSON command. For example in one embodiment, the command is as follows: {“jsonrpc”: “2.0”, “method”: “getGuide.Data”, “id”: I}.

Upon receiving the GetGuide command the TV forms a TV guide XML file by reading guide date from a database (DBM) and sends the guide XML to the DASH, as described for example with respect to FIG. 7. In one embodiment, the response form the TV is sent according to JSON RPC. For example, in one embodiment the response is as follows: {“jsonrpc”: “2.0”, “result”: “guide Data”, “id”: I}. Upon receiving the response message from the TV comprising the XML guide file, the DASH generates and displays a TV guide widget on the screen, according to the process described above with respect to at least FIGS. 4 and 5. In one embodiment, the guide widget is displayed in flash to show the TV guide listings on DASH.

At this point in the process the user is able to view the content listing displayed on the TV guide widget and selects any channel or programming Upon receiving the selection as described above with respect to FIGS. 4 and 5, the DASH, i.e. the secondary display device, generates a command, i.e. a channel change command and sends the command to the TV, and the command is received at the TV. In one embodiment, the command comprises a JSON command. For example in one embodiment, the command is as follows: {“jsonrpc”: “2.0”, “method”: “channel.change”, “params”: {“channel”, “15.1}, “id”: 2}.

Next the TV may parse, interpret and execute the change channel command to tune to the specific channel/programming selected by the user at the secondary display device. In one embodiment, in response to performing the command, the TV may provide the DASH with an acknowledgment message. For example, in one embodiment a JSON acknowledgment message may be sent from the TV to the DASH. In one embodiment, for example, the acknowledgment message is as follows: {“jsonrpc”: “2.0”, “result”: “success”, “id”: 2}.

The present methods and techniques enhance the TV viewing experience. First by providing a secondary device external to the main display device, the user can view menu and guide information while maintaining the full size display of main content at the display device. Furthermore, by providing an alarm feature, the present invention gives facility to the user to watch his/her favorite program. In several embodiments, the implementation cost of the above methods and techniques is minimized because guide and menu data already exists on the main display device and the only significant changes involve adding a JSON server on the main display device and, a JSON client and flash application on the secondary display device. This feature thus enhances the viewer experience and showcases the compatibility between two devices.

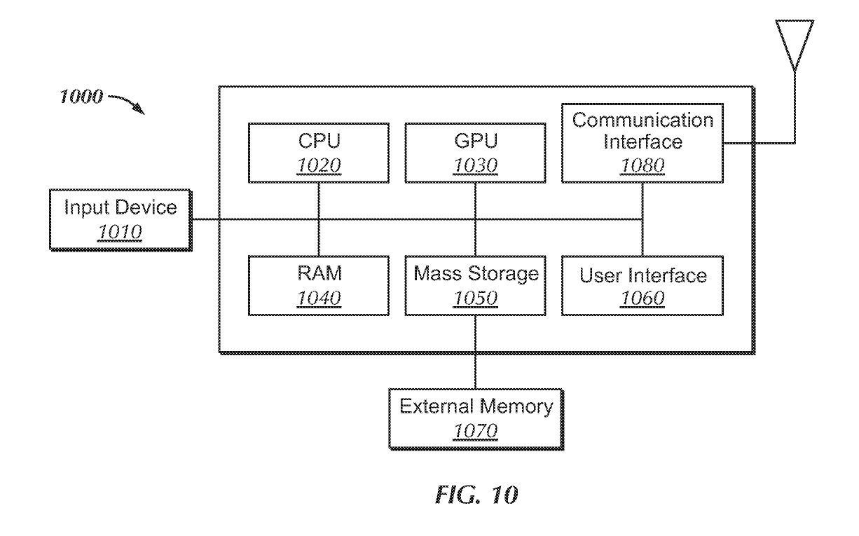

The methods and techniques described herein may be utilized, implemented and/or run on many different types of systems. Referring to FIG. 10, there is illustrated a system 1000 that may be used for any such implementations. One or more components of the system 1000 may be used for implementing any system or device mentioned above, such as for example any of the above-mentioned devices, applications, servers, databases, etc. However, the use of the system 1000 or any portion thereof is certainly not required.

By way of example, the system 1000 may comprise a Central Processing Unit a User Input Device 1010, (CPU) 1020, a Graphic Processing Unit (GPU) 1030, a Random Access Memory (RAM) 1040, a mass storage 1050, such as a disk drive, a user interface 1060 such as a display, External Memory 1070, and Communication Interface 1080. The CPU 1020 and/or GPU 1030 may be used to execute or assist in executing the steps of the methods and techniques described herein, and various program content, images, games, simulations, representations, communities, interfaces, etc. may be rendered on the user interface 1060. The system 1000 may further comprise a user input device 1010. The user input device may comprise any user input device such a keyboard, mouse, touch pad, game controller, etc. Furthermore, the system 1000 may comprise a communication interface 1080 such as a communication port for establishing a communication with one or more other processor-based systems and receiving one or more content. In one embodiment, the communication interface 1080 may further comprise a transmitter for transmitting content, messages, or other types of data to one or more systems such as secondary display devices, applications and/or servers. The system 1000 comprises an example of a processor-based system.

The mass storage unit 1050 may include or comprise any type of computer readable storage or recording medium or media. The computer readable storage or recording medium or media may be fixed in the mass storage unit 1050, or the mass storage unit 1050 may optionally include external memory and/or removable storage media 1070, such as a digital video disk (DVD), Blu-ray disc, compact disk (CD), USB storage device, floppy disk, or other media. By way of example, the mass storage unit 1050 may comprise a disk drive, a hard disk drive, flash memory device, USB storage device, Blu-ray disc drive, DVD drive, CD drive, floppy disk drive, etc. The mass storage unit 1050 or external memory/removable storage media 1070 may be used for storing code that implements the methods and techniques described herein.

Thus, external memory and/or removable storage media 1070 may optionally be used with the mass storage unit 1050, which may be used for storing code that implements the methods and techniques described herein, such as code for generating and storing the tag data described above, performing the initiation of a session, evaluating, and matching of the users. However, any of the storage devices, such as the RAM 1040 or mass storage unit 1050, may be used for storing such code. For example, any of such storage devices may serve as a tangible computer storage medium for embodying a computer program for causing a console, system, computer, or other processor based system to execute or perform the steps of any of the methods, code, and/or techniques described herein. Furthermore, any of the storage devices, such as the RAM 1040, mass storage unit 1050 and/or external memory 1070, may be used for storing any needed database(s), tables, content, etc.

In some embodiments, one or more of the embodiments, methods, approaches, and/or techniques described above may be implemented in a computer program executable by a processor-based system. By way of example, such processor based system may comprise the processor based system 1000, or a computer, entertainment system, game console, graphics workstation, etc. Such computer program may be used for executing various steps and/or features of the above-described methods and/or techniques. That is, the computer program may be adapted to cause or configure a processor-based system to execute and achieve the functions described above. For example, such computer program may be used for implementing any embodiment of the above-described steps or techniques for generating tag data and matching players based on the tag data, etc.

As another example, such computer program may be used for implementing any type of tool or similar utility that uses any one or more of the above described embodiments, methods, approaches, and/or techniques. In some embodiments, the computer program may comprise a video game, role-playing game (RPG), or other computer simulation. In some embodiments, program code modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

Therefore, in some embodiments the present invention provides a computer program product comprising a medium for embodying a computer program for input to a computer and a computer program embodied in the medium for causing the computer to perform or execute steps comprising any one or more of the steps involved in any one or more of the embodiments, methods, approaches, and/or techniques described herein.

For example, in some embodiments the present invention provides a computer-readable storage medium storing a computer program for use with a computer simulation, the computer program adapted to cause a processor based system to execute steps comprising sending an data request from a secondary display device to a main display device for menu data present on the main display device, wherein the main display device is capable of performing a set of functions and wherein the menu data corresponds to the set of functions, receiving the menu data associated with the data request, generating a menu at the secondary display device according to the data and displaying the menu such that the menu provides the user with means for viewing one or more of the set of functions, receiving a selection with relation to the menu to perform at least one function of the one or more of the set of functions from a user at the secondary display device and sending a command to the main display device to perform the at least one function corresponding to the selection to cause the at least one function to be performed at the main display device.

In another embodiment, the present invention provides a computer-readable storage medium storing a computer program for use with a computer simulation, the computer program adapted to cause a processor based system to execute steps comprising sending an data request from a secondary display device to a main display device over a communication channel for data present on the main display device, wherein the data comprises data corresponding to a program guide present at the main display device, the program guide comprising one or more selectable descriptors corresponding to one or more multimedia content, receiving the data corresponding to the data request, generating a program guide displaying the one or more selectable descriptors at the secondary display device, receiving a selection of a first one of the one or more selectable descriptors corresponding to a first one of the one or more multimedia content and sending a command to the main display device in response to the selection for causing the main display device to playback the first one of the one or more multimedia content for the user.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

1. A method comprising:
sending a data request from a secondary display device to a main display device for menu data present on the main display device, wherein the main display device is capable of performing a set of functions and wherein the menu data corresponds to the set of functions;
receiving the menu data associated with the data request;
generating a menu at the secondary display device according to the data and displaying the menu such that the menu provides the user with means for viewing one or more of the set of functions;
receiving a selection with relation to the menu to perform at least one function of the one or more of the set of functions from a user at the secondary display device; and
sending a command to the main display device to perform the at least one function corresponding to the selection to cause the at least one function to be performed at the main display device.

2. The method of claim 1, further comprising:
discovering one or more main display devices including the main display device; and
communicatively coupling to the one or more main display devices.

3. The method of claim 2, wherein discovering the one or more main display devices is in response to initializing the secondary display device.

4. The method of claim 2, wherein the one or more main display devices comprise devices in a home network connected to at least one of the secondary display device and another one of the one or more main display devices over a Local Area Network (LAN) connection.

5. The method of claim 1, wherein the secondary display device and main display device are connected to one another through a Local Area Network (LAN) connection.

6. The method of claim 1, wherein the menu data comprises a set of data provided from the main display device in an XML file.

7. The method of claim 1, wherein the command comprises a JSON command.

8. The method of claim 1, further comprising:
receiving the command at the main display device;
translating the command to a executable command implemented in a protocol that is executable by the main display device; and
executing the executable command at the main display device causing the at least one function to be performed at the main display device.

9. The method of claim 1, wherein the at least one function comprises sending program guide data present at the main display device to the secondary display device, the program guide comprising one or more selectable descriptors corresponding to one or more multimedia content.

10. The method of claim 9, further comprising:
receiving the program guide data; and
generating a program guide displaying the one or more selectable descriptors at the secondary display device;
receiving a selection of one of a first one of the one or more selectable descriptors corresponding to a first one of the one or more multimedia content; and
sending a command to the main display device for causing the main display device to playback the first one of the one or more multimedia content.

11. The method of claim 1, further comprising:
receiving a request to edit the menu at the processor-based device; and
generating an edited menu in response to the request.

12. The method of claim 11, further comprising:
determining menu data required for generating the edited menu; and
requesting the required menu data from the main display device.

13. The method of claim 1, wherein the set of functions are further configured to be displayed to the user as one or more menus at the main display device.

14. A device comprising:
a processor configured to perform steps comprising:
sending a data request from a secondary display device to a main display device for menu data present on the main display device, wherein the main display device is capable of performing a set of functions and wherein the menu data corresponds to the set of functions;
receiving the menu data associated with the data request;
generating a menu at the secondary display device according to the data and displaying the menu such that the menu provides the user with means for viewing one or more of the set of functions;
receiving a selection with relation to the menu to perform at least one function of the one or more of the set of functions from a user at the secondary display device; and
sending a command to the main display device to perform the at least one function corresponding to the selection to cause the at least one function to be performed at the main display device.

15. The device of claim 14, wherein the processor is further configured to:
discover one or more main display devices including the main display device.

16. The device of claim 14, wherein the at least one function comprises sending program guide data present at the main display device to the secondary display device, the program guide data comprising one or more selectable descriptors corresponding to one or more multimedia content.

17. The device of claim 14, wherein the data comprises a set of data provided from the main display device in an XML file.

18. The device of claim 14, wherein the command comprises a JSON command.

19. A tangible non-transitory computer readable medium storing one or more computer readable programs adapted to cause a processor based system to execute steps comprising:
sending a data request from a secondary display device to a main display device for menu data present on the main display device, wherein the main display device is capable of performing a set of functions and wherein the menu data corresponds to the set of functions;
receiving the menu data associated with the data request;
generating a menu at the secondary display device according to the data and displaying the menu such that the menu provides the user with means for viewing one or more of the set of functions;
receiving a selection with relation to the menu to perform at least one function of the one or more of the set of functions from a user at the secondary display device; and
sending a command to the main display device to perform the at least one function corresponding to the selection to cause the at least one function to be performed at the main display device.

20. A method comprising:
sending a data request from a secondary display device to a main display device over a communication channel for data present on the main display device, wherein the data comprises data corresponding to a program guide present at the main display device, the program guide comprising one or more selectable descriptors corresponding to one or more multimedia content;
receiving the data corresponding to the data request;
generating a program guide displaying the one or more selectable descriptors at the secondary display device;
receiving a selection of a first one of the one or more selectable descriptors corresponding to a first one of the one or more multimedia content; and
sending a command to the main display device in response to the selection for causing the main display device to playback the first one of the one or more multimedia content for the user.
